(19) United States
(12) Patent Application Publication
(10) Pub. No.: US 2002/0055972 A1
(43) Pub. Date: May 9, 2002

(54) Dynamic content distribution and data continuity architecture

(76) Inventor: Joseph Bernard Weinman JR., Basking Ridge, NJ (US)

Correspondence Address: Samuel H. Dworetsky, AT&T CORP., P.O. Box 4110, Middletown, NJ, 07748-4110, US

(21) Appl. No.: 10/026,488

(22) Filed: Dec. 19, 2001

Related U.S. Application Data
(63) Continuation-in-part of application No. 09/828,869, filed on Apr. 10, 2001.
(60) Provisional application No. 60/202,661, filed on May 8, 2000.

(51) Int. Cl. G06F 15/16

(52) U.S. Cl. 709/203; 709/217

(57) ABSTRACT

The invention is a system and method for managing data objects in a network or networks such that there may be at least n copies of the data object and each copy of the data object may be separated by at least a distance of d. In the event of a disaster and loss of a data object, there may be at least n−1 copies of the data object remaining at various sites in the network. Information relating to the identity of each data object and location may be maintained in a central server or distributed in a doubly linked structure, for example. Further, the data object may be copied to storage locations in proximity to requesting sites resulting in an increased number of copies of the data object. Less often or less recently accessed copies of the data object may be subsequently removed to return the number of copies to n. In another embodiment, data may be lost, thus reducing the number of copies to below “n”. New copies are created and re-inserted into the network to maintain the minimum number of copies of the data object in the network separated by at least a distance of d.

This Application is a continuation-in-part of pending U.S. patent application Ser. No. 09/828,869, filed Apr. 10, 2001, entitled “Method and Apparatus for Maximizing Distance of Data Mirrors” which claims the benefit of U.S. provisional application No. 60/202,661.

### FIELD OF THE INVENTION

The present invention relates to a method for distribution of information within a network and, more particularly, to a method utilizing a distributed caching approach for ensuring data survivability by dynamically replicating the information at a number of sites and maintaining at least a predetermined minimum number of mirror sites containing the information.

### BACKGROUND OF THE INVENTION

Today, data has become a mainstay of our world. Customers demand data to be accurate, up-to-date and readily available. An example of an industry where accurate and up-to-date data plays a vital role is in the banking industry. Clearly, account information must be accurate for each customer. If this information is unavailable or lost, serious problems would ensue including customer dissatisfaction, loss of money, even lawsuits. In fact, across all industries and for personal use, data has value, which may range from qualitative value such as the emotional value of a digital video of a child's birthday party to the quantitative value which may be associated with business data by assessing the costs to collect, calculate, and create data or the opportunity costs or penalties associated with the loss of such data. There are many such examples of the importance of data in the lives of modern man.

Distribution of content across a network has been gaining popularity. Content such as images, databases, binary files such as executable software, or streaming video, and also text, may be distributed throughout the Internet based on user requests or according to a provider's plan for geographic coverage. Sometimes this is done according to a plan for distribution, as is used in content distribution services or networks. Other times, this happens essentially “by accident”, as users make a local copy of a certain data object, such as a spreadsheet or presentation, mail another user a copy of the object, as an attachment, or utilize a backup capability such as a network drive. While growth of the number of copies has benefits in terms of ease of access to information, uncontrolled proliferation of these copies can lead to exponential growth in storage requirements and concomitant costs. In any event, these activities are often intended to ensure that users have rapid access to needed information. Such data transfers for replication can have high bandwidth requirements and/or high storage requirements. An example of this is video files that must be delivered to user terminals rapidly in order to provide for a fluid video.

Internet content is often located in a distant site from the sites of usage. In an effort to more readily and rapidly provide for content, mirror sites have been employed wherein information is copied or mirrored from a primary site to secondary sites. When information contained in the primary site is requested, the request is routed to and served from a secondary site containing the identical information closer to the requesting site. This can reduce traffic bottlenecks and speed access to the information. In this scheme, copies of the data are provided at various sites throughout the network in such a way as to maximize the likelihood that any request site would be located close to a mirror site containing the desired data.

In order to ensure that any request site would be located close to a copy of the data, a large number of copies would need to be provided at many mirror sites. For example, if the data is located in London, one would mirror the data to sites throughout the world to ensure easy access. If it is known that data requests are high in, for example, Cleveland, then copies would ideally be mirrored to the Cleveland area. Although copies would be provided at locations of known high usage of the data, it is not always possible using this scheme to ensure that every request would be located close to the data being requested, especially requests in areas of low to moderate usage. For example, if data requests are uncommon in Belize, a copy would not likely be provided in Belize in order to save resources. However, if a user in Belize does request the data, then there may not be an existing copy nearby and delays would be prohibitive. Increasing the number of copies of the data to resolve this problem, however, may waste resources and degrade performance. As an example, if mirrored copies were provided in the Belize area and very few requests or perhaps no requests at all were ever received for the data, then storing the data at such a site would not be cost effective.

Although often used colloquially, it is beneficial to clarify the use of the term “copy” in this application. A data object may be created, e.g., as in the creation of a patent application in a word processing program. By a variety of techniques, in either a local or network file system, a copy of that object may be created, i.e., an exact duplicate. We sometimes use the term “original” or “primary” data object to refer to the original first creation, and “copy” to refer to the one or more duplicates that may be made. However, we also refer to “copies” of the object to signify the entire set of instances of the object. It should be clear from context which meaning is intended.

Data mirroring, and related techniques such as content replication, caching, and content distribution, have many applications in the modern world. Maintaining accurate, up-to-date and readily available data is of critical importance and many enterprises and organizations have begun to rely on data mirroring to achieve this end. In the past, industries had relied on creating backup data in case a disaster occurred that would result in the loss of data. One method included copying data on disk to tape, such as DLT tape. However, the backup tapes were often stored in the same building as the primary site; and if a disaster occurred in the building in which both the primary site and the backup tapes were stored, all would be destroyed or otherwise inaccessible. Therefore, this proved to be ineffective in preserving data. The tapes could also be stored in a separate building such that if a local disaster in the building housing the primary site, such as fire or bombings, occurred, the backup tapes would be preserved in a geographically separate location and could be reinstated once the disaster was resolved. However, this method required a slow process of relocating proper backup tapes at the remote site, transporting the tapes back to the primary site and possibly quiescing or bringing the system down temporarily while the data was uploaded. This meant that the system was unavailable during this length of time, the length of time potentially being substantial. Furthermore, there would be no guarantee that the data on the backup tapes was current as any number of transactions or changes to the data could have occurred since the backup tapes were updated. Even if the tapes were backed up every few days, it would be highly likely that in the event of a real disaster, the information contained on the tapes would be obsolete. In light of these shortcomings of the method of backing up data to tapes, it was clear that an alternative and more effective method of backing up data was necessary.

In preserving data without the problems of using backup tapes, data mirroring proved useful in data preservation. Data at a primary site is mirrored to a distant secondary site that is geographically removed from the primary site. In case of calamity and data destruction or access loss, the data is preserved at distant sites and data recovery can proceed. As long as the secondary sites are located a sufficient distance from the primary site such that the disaster affecting the first site does not affect the second site, the data can be preserved. In data mirroring, at least one copy of the data is mirrored to at least one site geographically separate from the primary site. Since an exact copy exists at the remote site, it is unlikely that the data would be destroyed in both the primary site and the remote site simultaneously.

However, the prior art techniques have several limitations. Currently, it is difficult to balance out multiple simultaneous requirements such as minimizing the total cost of storage, protecting against likely disasters by maintaining copies of the data sufficiently far apart, and minimizing total access times for reads and writes of the data. Policies, such as always maintaining two copies of the data or three copies (so that there is still a data loss prevention posture even in the event of one copy being lost) may be difficult to enforce. Also, even if these requirements and policies are met at a given instant, loss or corruption of a copy and duplication of copies may mean that they are no longer met seconds later or ever again. If the plurality of copies are too few or too close together, then a disaster, especially a disaster with far-reaching effects such as an earthquake or flood, could destroy the primary data as well as any copies of data located at mirror sites, leading to loss of data integrity. Excessively increasing the number of copies or the number of mirror sites containing the data would conversely produce a waste of resources. In this scenario, as copies continue to increase, there would be a need to delete excessive copies as these copies would adversely affect system performance. With redundant copies of the data, some of the copies may be accessed infrequently and would not be needed. However, with the current lack of means for determining the minimum effective number of mirror sites and a means for maintaining the effective number of mirror sites, maintaining the proper minimum number of mirror sites such that data preservation would be accomplished with minimal impact on performance is very difficult. In addition, in the event of a disaster and data loss, it is often difficult to identify which data may have been lost. If damaged data cannot be clearly identified, it is difficult to target the data for duplication and replacement. Compounding all of these problems is the need for maintaining copies of data close to data request sites without needlessly increasing the number of copies of data throughout the network.

Thus, a need exists in the art for maintaining multiple copies of mirrored data such that there are always at least a minimum number of copies of the data in the network to ensure data continuity and substantially zero data loss and to minimize access time to that data, and that in the event of loss of a facility or other disaster, survivability of data is ensured.

There is also a need in the art for monitoring and deleting excess copies of mirrored data if the number of copies of the mirrored data at mirrored sites are infrequently accessed and the number of copies of the data is substantially greater than a predetermined number—typically determined based on an organization's disaster recovery or business continuity policy as well as a storage cost management policy—to maintain the number of copies of the mirrored data, i.e., an organization may dictate that there must always be at least three copies of mission critical data, no more than ten copies of important data, and no more than twenty copies of mission critical data.

There is also a need in the art for identifying and dynamically creating and re-inserting mirrored data if the copies of mirrored data have been lost due to a disaster such that a minimum number of copies for the mirrored data would be maintained.

### SUMMARY OF THE INVENTION

The present invention solves the above-mentioned problems by providing a method and means for data dispersion such that at least n copies of any specified data objects fitting a set of criteria are maintained on a network in such a way that no two copies are located within m miles of each other. Optionally and advantageously, an additional objective of maintaining no more than n+x copies (x>=1) may be also met. Copies of the data are dynamically made in conjunction with a caching algorithm and method—for example, to meet local user requests. If the number of copies of the data is reduced, due to cache removal policies such as “Least Recently Used,” or due to disasters, the number of copies of the data are carefully monitored to ensure that they don't fall below n. For example, if the nth copy is about to be removed from a cache location in New Jersey, either this removal would be stopped, or a new copy might be created in Kansas. If the New Jersey location was just rendered inoperable due to a hurricane, a copy might be created in Kansas from a version in California. Conversely, if there was a limit of 10 copies of that object, when a request came in from Miami, a new copy might be created in Miami. At that point, the copy of that object existing in Minneapolis might be deleted, because it had been accessed least recently out of all the copies. Many alternate embodiments exist here, e.g., the copy in Minneapolis might be pinned there, because that is where the corporate headquarters are, and the copy from Las Vegas removed instead.

In one exemplary embodiment, the invention provides for managing the maintenance of multiple copies of the data in multiple locations in a network via a central server that keeps track of the global number of copies of each object and their locations. In the event that the number of copies of the data falls outside of the predetermined threshold, the central server determines a current location or locations where copies should be deleted, or a new location or locations where copies should be created that meets the distance separation criteria. In so doing, the central server may consider such factors as the risk of disaster or loss in any particular location and the available storage capacity in each location. When an object is first created, it is mirrored to an additional n−1 mirror sites in the network (n>=2). In the event of a disaster and loss of the data, the number of copies of the data may decrease below n or in the event of additional copies of the data being created in the case of mirroring data to sites in proximity to requesting sites, for example, the number of copies of the data may increase above n. In either case, the number of copies of the data may deviate from n which would be reflected in the value provided in the global counter. The system would then either re-create copies of the data or delete redundant, infrequently accessed copies of the data to return the number of copies back to n, or to be less than n+x. A time threshold may be provided across all objects, for each specific object, or for categories of objects (e.g., mission critical objects, critical objects, important objects, and junk objects). This time threshold would dictate a limit as to how long the system may maintain “too few” or “too many” objects. The global counter and its related information, such as possible and actual storage locations and their pairwise distances, can be on a single server or in itself mirrored for data loss mitigation reasons.

In another exemplary embodiment, the invention provides for maintaining multiple copies of data in multiple locations on a network such that all copies of the object reference “adjacent” copies, thus creating distributed information references for each object and its location in the network, which would typically be maintained with the data copies themselves. The distributed structure provides information on the identity and location of the data and may also contain a count of the number of copies of the data, the size of the data, the last access time or copy time of each copy of the data, and the like, thus providing a means for ensuring that the number of copies of the data on the network is at least n and at most n+x, where there are at least n copies maintained at least distance d from each other, and if not, for returning to that condition within time t. A doubly linked list, as is known in the art of computer science, is a data structure containing one or more data items or objects, where each object contains a reference to both the “next” object and a “previous” object. The objects, then, form a ring, with the first object pointing to the last object and the last object pointing to the first object. As used here, by doubly linked structure we mean a set of distributed objects, wherein each object is in a different location, and each object has such a next and previous reference. The value of this structure is that even if one object in the structure and its associated references are lost, as might happen in the event of a disaster, the links can be repaired based on the remaining information to return the reference pointers to a valid doubly linked architecture.

### BRIEF DESCRIPTION OF THE DRAWINGS

FIG. 1 illustrates an exemplary network utilizing a doubly-linked data structure represented by arrows.

FIG. 2 illustrates a method of creating a data object in a network.

FIG. 3 illustrates a method of deleting data objects from a network.

FIG. 4 illustrates modifying a data object in a network.

FIG. 5 illustrates deleting all copies of a data object in a network.

FIG. 6 illustrates deleting extra copies of a data object in a network.

FIG. 7 illustrates copying a data object in the vicinity of a user site.

FIG. 8 illustrates an exemplary central server.

FIG. 9 illustrates an exemplary Node Table of an exemplary central server.

FIG. 10 illustrates an exemplary Node Distance Table of an exemplary central server.

FIG. 11 illustrates an exemplary Object Copy Table of an exemplary central server.

FIG. 12 illustrates an exemplary Object Data and Rules Table of an exemplary central server.

### DETAILED DESCRIPTION

The present invention relates to a system and method for creating or maintaining data objects in a network or networks. The data objects are created or “mirrored” at a minimum number of sites designated “n” with each site separated by a minimum distance “d”.

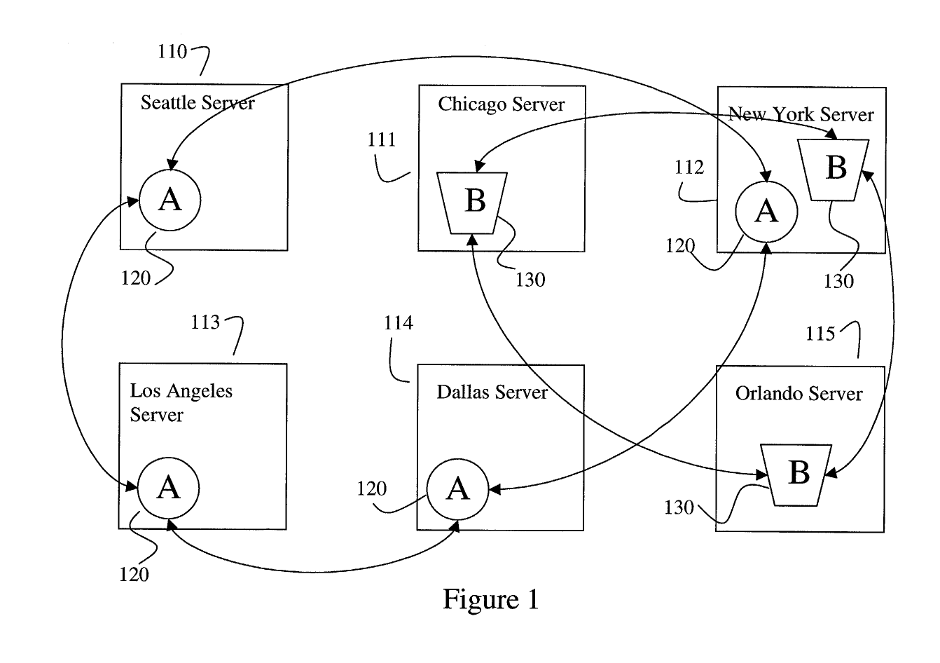

FIG. 1 illustrates an exemplary embodiment of the invention and shows six servers containing data objects. We use the term “server” generally to mean a combination of software, firmware, hardware, or other computer-related means of providing network, processing, and storage required to create, modify, delete, store, transmit, and receive data objects. As non-limiting examples of a server, such a server could be, e.g., a traditional web server, proxy-caching server, or content distribution server, but it could also be a midrange or enterprise (i.e., mainframe) server. It could also be a PC, PDA, wireless telephone, or embedded processor. It could also be an “intelligent” storage device, such as a disk drive, network attached storage, or RAID array. In the example of FIG. 1, one data object is designated as “A” 120 and one data object is designated as “B” 130. There are four copies (n=4) of object A 120 shown located on servers in Seattle 110, New York 112, Los Angeles 113 and Dallas 114. Three copies (n=3) of object B 130 are shown located on servers in Chicago 111, Orlando 115 and New York 112. The system maintains information on the copies of data through a doubly linked structure designated by arrows in FIG. 1. Thus, e.g., the server in Seattle 110 knows that there is an exact duplicate of A 120 in New York 112 and another in Los Angeles 113. Ideally, each copy of the data may have an associated counter, which enables the Seattle server 110, for example, to also know that there are four copies outstanding. It should be appreciated that the present invention could encompass any number of servers at any location and any number of data objects and is not limited to the exemplary cities or data objects illustrated in FIG. 1.

The doubly linked structure enables all copies of the data object to reference neighboring copies, thereby providing information on the identity and location of each data object. In this way, each server may be provided with information on the location of each copy of the data object and the probability of data survivability in the event of a disaster based on distance from the site of disaster, for example. The doubly linked structure may also contain other information such as a variable for indicating the minimum or maximum number of objects, locations in the network or networks, or the last time each object was referenced or copied, for example.

The doubly linked structure is intended to be exemplary of a peer-to-peer metadata management data structure. It is advantageous in that it is robust in the event of the loss of metadata at a single node, and in that the amount of metadata required in total is linear in the number of copies. In addition, from any given copy, it is possible to rapidly and easily navigate to any or all or the copies, either using the forward links or the reverse links. However, numerous variations can exist and are intended to be within the scope of the invention. For example, each copy of the data could contain references or pointers to more than two or even to all of the other copies. Or, the number of pointers could vary, e.g., some copies could refer to one or two of the other copies, some could refer to many or all of the other copies. A selection among these variations or whether to use a hybrid approach of a centralized and distributed metadata architecture depends, among other things, on whether the nodes are a permanent part of the network or can be detached, as a PC or laptop might be.

In the illustrative example depicted in FIG. 1, if a disaster occurred in Dallas 114, the system would know the locations of each of the other copies of the data object A 120. Servers located sufficiently far away may be determined such that survivability of data can be assured. In this exemplary case, servers in Los Angeles 113, Seattle 110 or New York 112 may be identified as servers containing copies of the lost data. If a server is too close to the site of data loss, a determination may be made that the remote server is not sufficiently far away from the site of data loss and other servers located farther away may be identified. If a second site is located in close proximity to the first site where data is lost, the disaster causing the data loss at the first site may have affected the second site as well, or increased the probability that it may affect the second site in the near future, depending on the nature of the disaster. The illustrative system may contain a means for locating and identifying sites that are farther away, such as through a store and forward approach combined with a depth first search. Alternatively, such sites may be rapidly accessed through a preexisting table located on a central server. Or each site may maintain data on “near” sites as well as “far” sites. For example, if a secondary server was located in Fort Worth (not shown) and the site of disaster such as a hurricane leading to data loss was located in Dallas 114, it may be determined that the server in Fort Worth is too close to the Dallas server 114 to have been “safe”. In this case, the distributed structure may allow alternative servers to be found such as in Los Angeles 113, Seattle 110 or New York 112, for example. It should be appreciated that any number of servers could be used in any practical location and the present invention is not limited to the servers and cities illustrated in the exemplary embodiment.

In this illustrative embodiment of the present invention, a server of the system is subjected to a disaster resulting in a loss of the data objects contained on the server. Detection of this disaster by other elements of the instant invention, such as a central server or distributed servers, can occur by means known in the art. For example, such means can include heartbeat signals exchanged on a regular basis between servers, centralized monitoring and management, or the like. In any event, the disaster may result in the number of copies of a given data object falling below the minimum number “n”. In this case, the doubly linked structure may identify the data that is lost such that new copies may be dynamically created and re-inserted into the doubly linked structure. This may maintain the minimum number of copies of the data object in the network at “n”. Following the return of functioning of the server, the content of the data object may be re-inserted into the overall system. If excessive copies occur, they may be subsequently deleted from the doubly linked structure. In addition, a mirror may be made elsewhere in the network of the metadata relating to the set of objects located on a server, e.g., a unique object identifier which may refer to its first location of creation and name, so that after a recovery phase, e.g., the replacement of such a server, the entire set of data objects is recovered from alternate copies located in the network.

The minimum number of copies (“n”) of a data object may be determined in a variety of ways. For example, “n” may be determined based on a corporate policy that is predetermined. Such a policy or corporate edict may be determined using any number of criteria such as, but not limited to, level of determined criticality of the data object (e.g., a higher “n” for data objects deemed more critical). Another method may be based on prior experience or the engineering design of certain objects. For example, some types of objects may be unable to tolerate corruption or errors, and therefore additional copies may be desired. In other cases, the desired n may depend on the cost to replace certain object types or specific objects, e.g., stock market ticker data is widely available from a variety of sources, but trade data for an individual's account may be irreplaceable, of large financial impact, and subject to SEC regulations regarding data protection. In yet another method, the user may, at the time of creating a new object, be prompted for the minimum n for that object. The minimum number of copies “n” may further be determined based on capacity of the system. If, for example, the system is currently utilized at high capacity, “n” may be set low as the system resources are relatively scarce. If, on the other hand, the system is currently utilized at low capacity, “n” may be set higher as the system resources are relatively abundant. It should be noted that these methods of determining “n” are for illustration purposes and the present invention is not limited to these methods, as any number of methods may be used.

If the number of copies of the data object falls below n, the risk of complete data loss increases, as does the average time for a random user to access that object. To avoid such risk, copies of the data object may be recreated at additional sites such that the number of copies of the data object is restored to n. A maximum number of copies of the data object may be maintained such that the number of copies does not exceed this value. The maximum value, n+x, where x>=1, is set so as to help ensure that storage space is not wasted. If the number of copies is excessive, then storage space is utilized for copies of the data object that are not necessary. Under these circumstances, the system may remove copies of the data object to restore the number of copies below n+x. Whether the number of copies is too low (below n) or too high (above n+x), the system may restore the number of copies to the proper value within a time period designated “t”. Restoring the number of copies within time t ensures optimal data preservation. Time t may be a function of the data being stored, location of the site, a function of latitude and longitude, or any number of factors pertinent to determining the time necessary to restore the number of copies to the proper amount.

Each of the copies of the data object in the network or networks may be separated by a minimum distance (“d”). By separating the copies of the data object by “d”, the probability of maintaining integrity is enhanced. The minimum distance “d” may be determined in a variety of ways and is not limited to the illustrative methods described herein. For example, “d” may be set to a standard distance (e.g., 15 miles) that may be determined by any number of criteria. “d” may also be determined implicitly. Using this implicit method, “d” is characterized by relative positions such as “2 node separation” or “2 hops”, for example. As a non-limiting example, if a network contained 4 nodes A-B-C-D, a determination of “d” may be “2 hops” such that locations where copies of the data object are stored must be separated by 1 node. In this example, A and C would be permissible but A and B would not be. As an alternative method, “d” may be adjusted by location-dependent factors. For example, one location may be known to be a high-risk area for disasters covering broad ranges whereas another location may be known to have a low rate of such disasters. As a non-limiting example for illustrative purposes only, a 5-mile separation of locations in Maine, due to the low expectation of a far-reaching disaster, may be considered adequate for “d” whereas a 5-mile separation of locations in Miami with a high expectation of hurricanes (that cover a large area) may be considered inadequate for “d”.

In another exemplary embodiment, a data request is made from a site that is distant from existing servers containing the requested data. For example, if data object A was requested from a browser in Yokohama, Japan (not shown), the nearest server would be either in Seattle or Los Angeles. The distance for transmission of data between Seattle or Los Angeles to Yokohama remains long, which would result in a sub-response time and user experience. The present invention provides a system and method that dynamically moves or copies the data to a site that is close to the requesting site. At the same time, information contained in the doubly linked structure is updated to reflect the addition of another site containing the data object. In this example, data object A could be mirrored to a server which may be at least a distance d from a nearest location that also contains a copy of the data object such as in Tokyo (not shown) and the total number of servers containing data object A would increase to 5. As the requests for data object A increase, more copies would be created and inserted in the network. For example, requests may come from users with browsers, or other means of accessing and utilizing data objects, in Brussels, Moscow, Istanbul, Sydney, Tehran, Beijing and Johannesburg (not shown). Each of these requests may result in a new copy of data object A at servers located in close proximity to each of these cities. As this process continues, the number of copies of the data object would become excessive which may negatively impact system performance parameters, such as storage capacity required. For example, the number of copies would exceed n+x. The system of the present invention would maintain information on the number and location of copies of the data object in the doubly linked structure; and when this number became substantially greater than “n” (e.g., greater than n+x), copies may be deleted such that less often used copies are deleted to restore the total number of copies to at least n and at most n+x. If certain copies of the data object were not recently requested and the number of copies of the data was greater than “n+x”, those copies would also be deleted and storage space would be conserved.

In these illustrative embodiments, the doubly linked structure functions as a key component of a distributed data manager that maintains information on the locations in the network, the nodes in the network, the number of copies of each data object, and/or information regarding each data object, for example. Information on the number of copies of each data object enables the system to maintain the number of copies of the data object on the network or networks at or above n and below n+x, for example. Information on the nodes may indicate the number of components in the network that can store data, the storage capacity utilized at each node, the number of nodes currently containing data objects and the identity of those objects or the status of each of the nodes as data objects are shifted dynamically. Information on the location may indicate the opportunity to store data at a location such as storage space on a disk at a particular location, or may indicate information necessary for determining the proper minimum distance “d” between storage locations, the number of locations available, objects already stored at particular locations, size of those objects and the present requests for those objects based on users or agents associated with particular locations, for example. By users associated with a particular location, we mean those users that have a browser served by a particular content distribution site, those served by a proxy/caching server at the head-end of a cable network, those accessing data from within the data center holding the server, those dialing in over a dial-up network possibly in conjunction with a VPN, and so on.

In another embodiment of the invention, the system maintains information on the copies of data through a central index server. The central index server creates a centralized means for providing information on the copies of data in the network. The central index server contains metadata such as the size and owner and/or access permissions for each object, and the identity and location of each object such that all objects are identified and located easily. There may also be a count of the total number of data objects present in the network to optimize the speed of subsequent processing. In addition, last referenced or copied time of data objects enable proper selection of copies of data objects for deletion. For example, an extra copy of a data object that has not been referenced recently would be deleted if the number of copies of the data object in the network is substantially higher than “n+x”. The central index server may also contain information about the nodes in the network which may contain data objects. This information may include the capacity of each node, the cost of storage at each node, the capacity utilized at each node, its location, its distance from other locations, and the like.

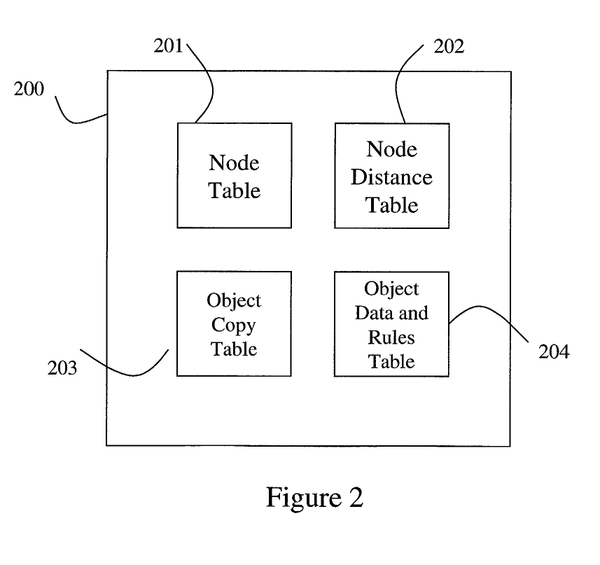

FIG. 2 illustrates an exemplary embodiment of the central index server. In this example, the central index server may contain a Node Table 201, a Node Distance Table 202, an Object Copy Table 203, and an Object Data and Rules Table 204. The Node Table 201 may contain information on the nodes such as capacity of the node or the location of the node. The Node Distance Table 202 may contain information on the distance between each of the nodes. The Object Copy Table 203 may contain information on each data object and/or location information for each data object. The Object Data and Rules Table 204 may contain information on each data object including number of copies, maximum and minimum numbers of copies, size, etc.

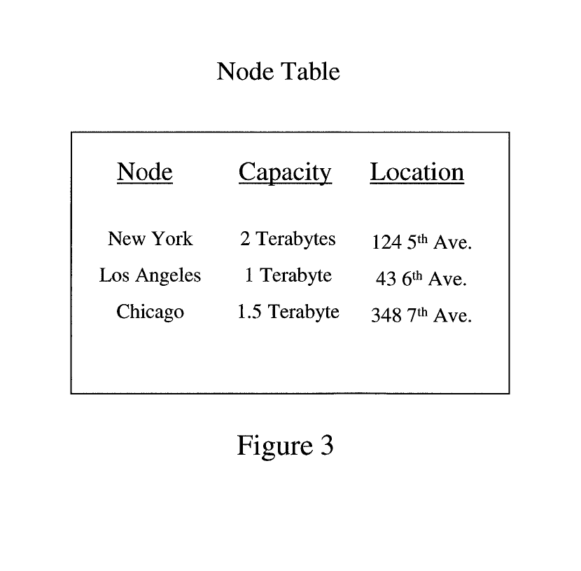

FIG. 3 illustrates an exemplary embodiment of the Node Table 201. In this example, information on each node is contained in the Node Table 201. FIG. 3 illustrates three cities, New York, Los Angeles and Chicago, as examples of node information that may be contained in the Node Table 201. However, it should be noted that the present invention is not so limited as node information may be located at any site. In the example illustrated in FIG. 3, the location of each node and the capacity of each node are specified.

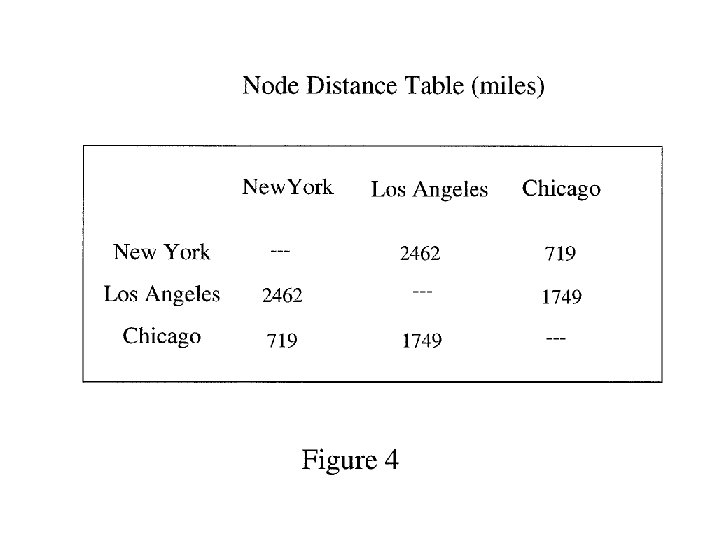

FIG. 4 illustrates an exemplary embodiment of the Node Distance Table 202. The Node Distance Table 202 may contain information regarding the distance between nodes. As an example, the distance between New York and Los Angeles in miles is contained in the Node Distance Table 202 (i.e., 2462 miles) or the distance between Los Angeles and Chicago in miles is contained in the Node Distance Table 202 (i.e., 1749 miles).

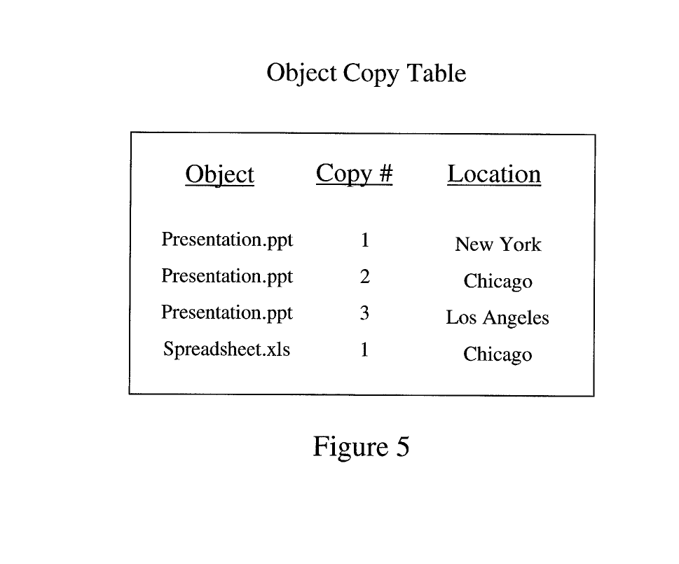

FIG. 5 illustrates an exemplary embodiment of the Object Copy Table 203. The Object Copy Table 202 may contain information on data objects. As FIG. 5 illustrates, the Object Copy Table 203 may contain a copy number of each copy of a data object and location information of each of the copies.

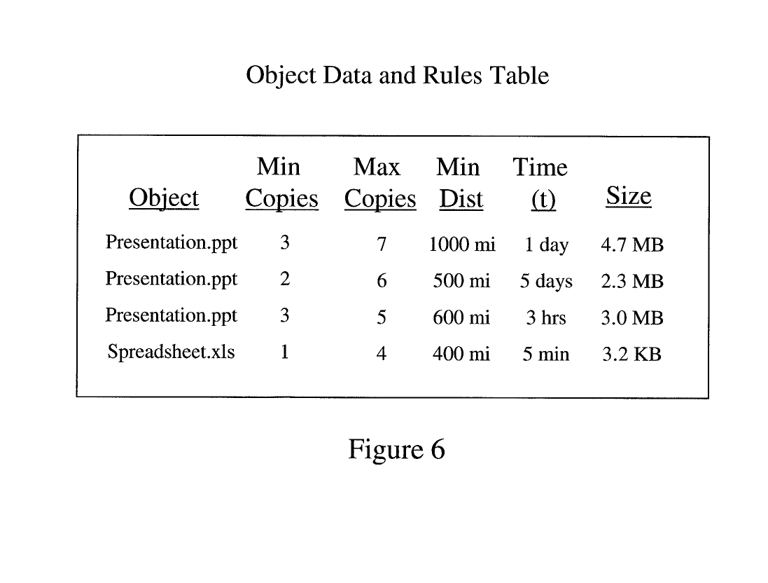

FIG. 6 illustrates an exemplary embodiment of the Object Data and Rules Table 204. The Object Data and Rules Table 204 may contain information on rules of each data object. For example, the Object Data and Rules Table 204 may contain information on the minimum number of copies for each data object (i.e., “n”), the maximum number of copies for each data object (i.e., “n+x”), the minimum distance between each data object (i.e., “d”), the time constant “t” or the size of the data object.

In this exemplary embodiment, a minimum number of copies of a data object “n” may be maintained on a network or networks, each data object being separated by a distance “d” such that copies of the data object are recreated and re-inserted into the network or networks if the number of data objects falls below n and copies of the data object are deleted from the network at predetermined locations if the number of data objects rises above n+x. Adjustment of the number of copies of the data object may be completed within time “t” to ensure data integrity and conservation of storage space. In this example, however, information on the data objects including the number of copies of the data object in the network or networks as well as other information such as but not limited to network node information or location information is stored in a central index server or a central “counter”. The central index server may provide data necessary for the maintenance of at least n copies of a data object in a network, each copy separated by a minimum distance “d”, and re-adjustments of the copies of the data object are completed within time “t”. The central index server may itself be replicated and distributed. If the central index server is itself distributed, the information may be dispersed in a peer-to-peer fashion or mirrored or duplexed to other sites. In this way, an additional layer of data protection may be provided as this data is distributed and not contained in one place only. Problems occurring in one geographical location may thereby have a lesser chance of destroying the information in the central index server.

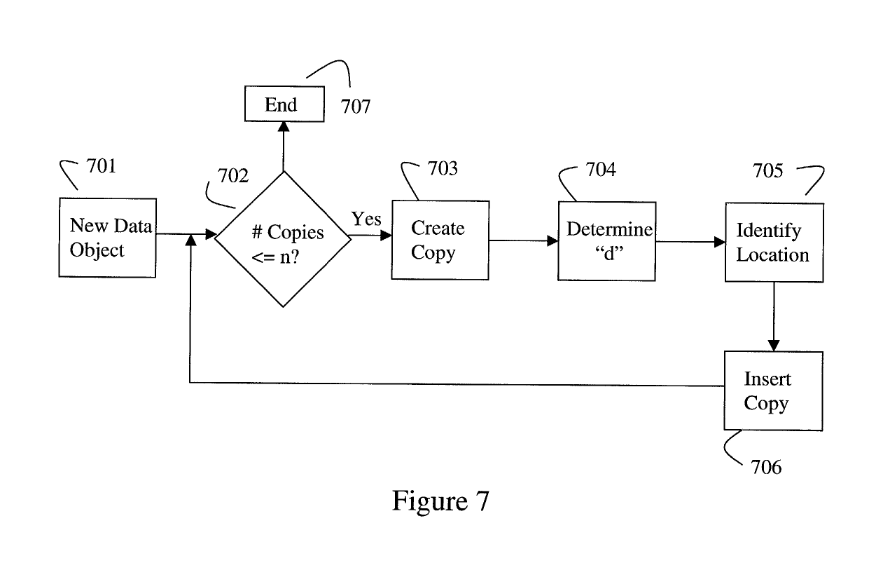

In all of these exemplary embodiments, any number of types of data object manipulation may be performed. For example, one non-limiting example involves creating new data objects in a network or networks wherein a new data object is created at a particular location. The illustrative embodiment is depicted in FIG. 7 wherein, within time “t”, n−1 additional copies of the data object are created and inserted into the network or networks such that the copies of the data object are each located at separate locations within the network or networks and separated by a minimum distance of “d”. A new data object is introduced into the network or networks (step 701) and the number of copies of the data object is determined (step 702). This may be determined through a central index server or through a distributed system such as a doubly linked structure or a distributed central index server, for example. If the number of copies of the data structure is less than n (i.e., the number of copies made thus far is less than n−1 ), a new copy is created (step 703). Placement of the copy is determined such that a minimum distance “d” from neighboring or “reachable” existing sites containing the data object is determined (step 704) and a copy of the data object is stored at a desired location (step 705, step 706). As part of creating the copy (step 703), metadata information is also updated, such as the number of copies, distributed link information, and/or central server information. If the number of copies reaches n, the process may end (step 707). Alternatively, if conditions are such that additional copies of the data object are desired, then additional copies of the data object may be created up to a maximum of n+x (not shown). The location selected may be a minimum distance from another location containing the data object as well as according to a variety of other variables such as but not limited to capacity of the location, type of node, degree of usage at the location, etc. and may be subject to separation of the copies by a minimum distance of “d”. These steps are intended to be exemplary. For example, in a rapidly changing object such as a transactional database, a “snapshot” may be taken as is known in the art to execute step 703, and then transmitted to a distant location and stored there to execute step 706. In an alternate embodiment, step 705 may occur first, and then steps 703 and 706 may be identical, as, e.g., during a file transfer operation (where the file is copied).

The method described above is intended to be exemplary and non-limiting. For example, a variety of protocols may be used to support copying. For small n, such as n=2 or n=3, a first copy may be made of the original, and then a second copy made, as described above. For larger n, a variety of multicasting protocols may be used, either to quickly distribute the copies to all copy locations, or to an initial set which then forwards copies on to the next set, and so on, until the minimum n copies exist in a valid set of locations. To do this, an object management layer, primarily implemented from a central location, or evenly distributed across multiple or all locations, may direct copies to move or be created. Or objects may be “packaged” with instructions as to further sites to be copied to and may, in effect, self-propagate through the network. During copying, an object may be copied in its entirety to an initial location, and then recopied; or it may be streamed from its first location to a second location, and then, even before it has been fully copied to that second location, recopying may begin of the initial part of the object to copy it from the second location to the third location in parallel (or as it is commonly referred to, as a pipeline) with the copying proceeding from the first location to the second location. Use of the data, e.g., video playback of a video stream, may occur concurrently with the recopying to a next location. Copying of data objects may occur at one layer in the overall system architecture, e.g., the file system layer, while transmission of objects from one location to another may occur at another layer, i.e., the network layer. Alternatively, the layers may essentially be identical, e.g., a combined store and forward and storage device, as described in pending U.S. patent application Ser. No. 09/828,869, filed Apr. 10, 2001, entitled “Method and Apparatus for Maximizing Distance of Data Mirrors” incorporated herein. Here, a copy being sent from location A to location Z via network node locations B, C, D, . . . X, Y would be considered to exist not only at locations A and Z, but also as it is being transferred from B to C, from C to D, from D to E, and so on. Therefore, there are two copies when there is a copy at A and C, when there is a copy at A and D, and so on. In fact, there may momentarily be three copies, as at the end of a copy from D to E when, for an instant, not only is there the primary copy at A but there is a full copy at E which has just come into existence and a full copy at D which is just about to be deleted.

Determination of the location of the copies may be done as described above, i.e., in a sequential, iterated cycle: determine next location, make copy, determine next location, make copy, determine next location, make copy, etc. Or the copying may proceed in two phases. In a first phase, the locations for the n copies to be distributed to may be determined; and in a second phase, the copies actually distributed. Such determination may be made using a variety of algorithms and constraints. Rules may be used that require that, e.g., of 12 copies, one must be in New York, one in Japan, and one in London, and the other nine can be anywhere. Or there may be a rule that at least m of the n copies (m<=n) be subject to distance separation requirement d₁, whereas the remainder be subject to distance separation requirement d₂. Or that ml copies be subject to distance separation requirement d₁, m₂ copies be subject to distance separation requirement d₂, m₃ copies be subject to distance separation requirement d₃, all the way up to mᵣ copies be subject to distance separation requirement dᵣ, with n<=Σmᵢ<=n+x.

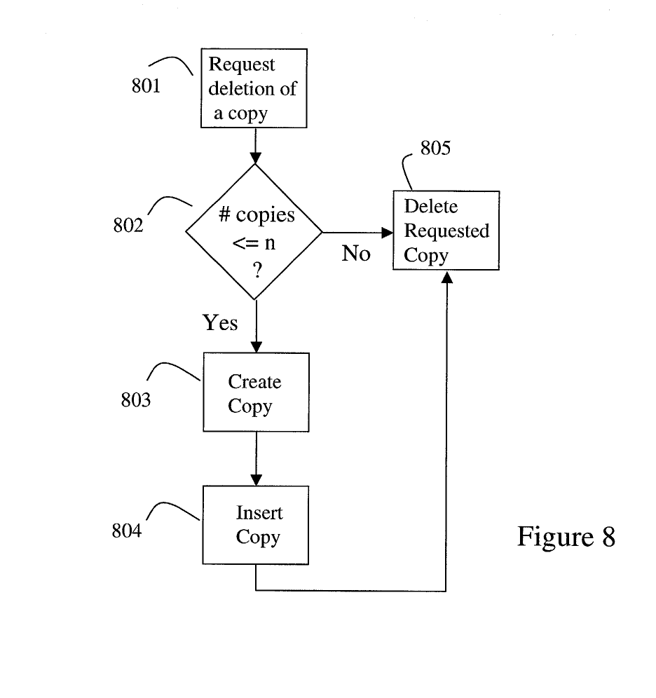

Other criteria may be used to select a set of locations for a given object at a given time. These may include the cost or time to transmit copies along network links, or the storage capacity utilization at a given location, for example. A variety of algorithms and heuristics may be used to determine a valid mapping of object copies to locations. For small n, an algorithm which iterates through every possible mapping and finishes when it finds a valid one, i.e., one that meets all the rules such as distance constraints, storage capacity utilization, and the like, may work efficiently, especially when d is much less than the average inter-location distance, and n is substantially less than the number of locations. On the other hand, algorithms such as simulated annealing may be useful under other circumstances, especially when d is close to the average inter-location distance, and a number of locations are clustered together with inter-location distances less than d. The method described in FIG. 7 may also (not shown) invoke the method described below in FIG. 8 to delete copies of an object, or another method (not shown) to move copies of an object. This may be because an object is required to be at a certain location, but its size is greater than the available free space at that location. To make room for the object, another object may have to be moved, subject to its own rules.

Another exemplary embodiment, illustrated in FIG. 8, involves a method of removing a copy of a data object from a network or networks, either based on user request (e.g., I remove a presentation from my PC), or based on a request internally generated from the system of the instant invention. In this example, a request to delete an object is provided (step 801) and either a distributed system such as one utilizing a doubly linked structure or a central index server may determine if the copy of the data object may be deleted. Alternatively, a copy of the data object may be lost and the total number of copies of the data object may fall below n. This may be due to a variety of reasons such as but not limited to data corruption, accidental deletion, disaster that destroys data, loss of a location, etc. As an example and for illustration purposes only, it may be determined that there may be an insufficient number of copies of the data object on the network if the copy is deleted (e.g., total number of copies on the network is n−1 after the copy is deleted (step 802)) and therefore the data object may not be deleted. Alternatively, an additional copy of the data object may be created (step 803) and inserted (step 804) into another site separated by a minimum distance of “d” from other existing sites prior to deleting the requested copy (step 805) so that the minimum number of copies is maintained at or above n. As part of creating a new copy (step 803, 804), or deleting the copy (step 805), metadata such as the number of copies, location, doubly linked object references, and/or central server information may also be updated. If a data object is destroyed, it may be recreated and re-inserted into the network or networks such that the total number of copies of the data object is at least n and the copies are at locations separated by at least a distance of d as described. Readjustment of the copies of the data object may be completed within a time “t” for optimum data safety.

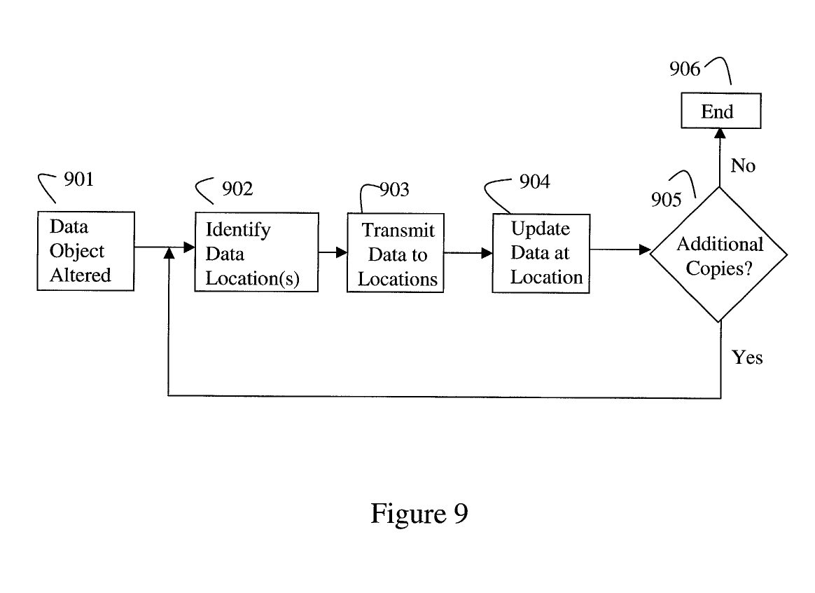

In another exemplary embodiment as illustrated in FIG. 9, a data object is altered at a site (step 901). Information is obtained, for example, through a distributed system such as a doubly linked structure or a central index server such that the at least n copies of the data object are located (step 902), the modified data is re-created (step 903), i.e., transmitted to the multiple locations where the at least n copies are resident, and are updated at the respective locations (step 904) to reflect the changes. If additional copies need to be updated (step 905), more copies of the data object are created and inserted at the proper locations. In one variation of this exemplary embodiment, a modified data object replaces the older version of the data object. In another variation, only the changes or “deltas” are transmitted to all the locations, together with instructions or information which allows these changes to be appropriately applied. The time t can be used to determine the speed at which these changes propagate. If t is very short or zero, the changes may be required to propagate, be applied, and confirmation received among all of the copies that the changes have been applied. In another variation, the changes are applied such that version history is maintained with each object. In another variation, the changes are applied and confirmed, but do not take effect until a predetermined date/time.

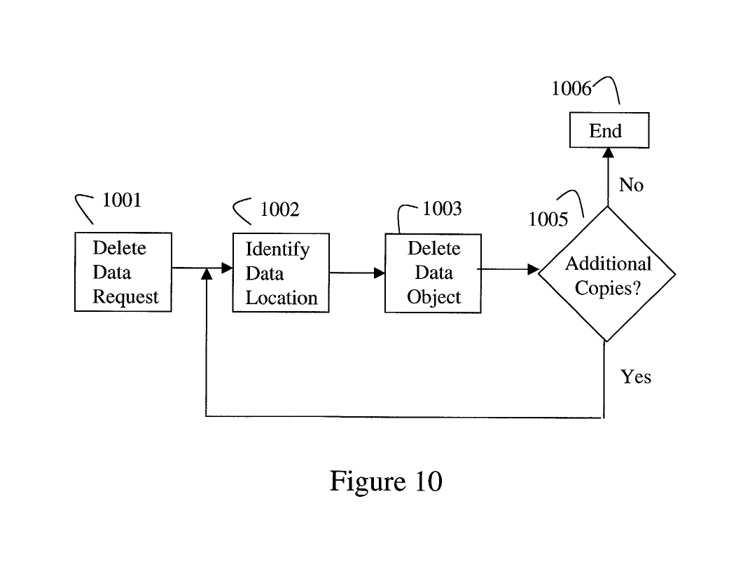

In another exemplary embodiment shown in FIG. 10, all copies of a requested data object are deleted (step 1001). Information from, for example, a distributed system such as a doubly linked structure or a central index server is obtained for the copies of the data object on the network or networks (step 1002). The copies and their locations are identified and the data objects are deleted (step 1003). If additional copies are identified (step 1005), they are deleted. This method is intended to be exemplary. As with the previously described methods, other specific alternate embodiments may be used. For example, a deletion message could be broadcast to all nodes, or multicast to those nodes with the data object resident via a multicast protocol such as PIM-SM (Protocol Independent Multicast) sparse mode. Such a message could be sent as a datagram, or the deletion could be acknowledged back at the central server. Or the doubly linked structure could be navigated, and at each step (i.e., next node) in the navigation, the deletion could occur. Or the central index server could mark the object as deleted, and each node, upon receiving a local access request, could check with the central server to see whether the object still is “live” before serving it. Or each node could periodically poll the central server for a status of all of its objects, or to check a “recently deleted” list to determine whether any of the objects it had were no longer “alive.”

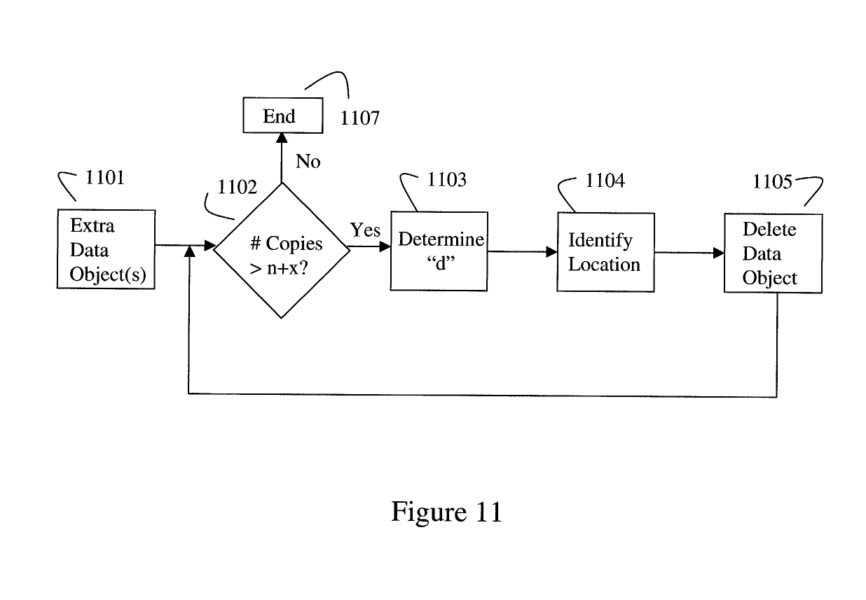

In another exemplary embodiment as illustrated in FIG. 11, the number of copies of a data object are excessive for the amount of storage space available (step 1101). This may occur, for example, when the total number of copies of the data object exceed n+x (step 1102). In fact, it also may occur even if the number of copies is well below the respective n+x for each object, such as when there exist many objects relative to the amount of storage capacity. If the number of copies of the data object are excessive, a distributed system such as one supported by a doubly linked structure or a central index server provides information as to the distance separating the copies of the data object (step 1103) and characteristics and location of nodes containing the data object (step 1104). Based on maintaining at least n copies of the data objects on the network or networks with each copy being separated by at least a distance “d”, the excessive copies are deleted within time “t” (step 1105). In this way, the network is optimized in terms of efficiency and conservation of storage space, for example.

It is worth noting that different embodiments and variations of time constant t are envisioned to be within the scope of the invention. For example, there may be a t_{c} representing the time in which additional copies must be made to bring the total number of copies of an object up to the minimum n, a t_{d} representing the time in which a deleted or destroyed copy must be restored to restore the total number of copies of an object back to the minimum n, a t_{c} representing the time in which excessive copies (i.e., more than n+x) must be deleted, and so on. And different strategies may be used to manage these times. For example, the aforementioned tₑ, which represents the limit of time for the existence of excessive copies, may optionally be renewed or extended by a user. Thus, e.g., if a business user has a PC or laptop that has a copy of data which is readily accessible from the network servers, perhaps a corporate policy to prevent unnecessary laptop storage growth might set tₑ to be a month. Near the end of that month, the user could be prompted to extend the life of that object on their device. Or the object could automatically be deleted unless it had been accessed, with each access extending the life of the data. Note also that t may be set to 0. For example, if the time t_{c}, which represents the time available before n sufficiently distributed copies must be available, is set to 0, that means that all copies must be made “instantly.” While this is not possible, due to propagation delays for network communications, what is possible is for the network to create all copies as a single atomic transaction, and not report completion of the creation or updating of the object initially until all copies of the object, or updates to the object, have completed and been acknowledged.

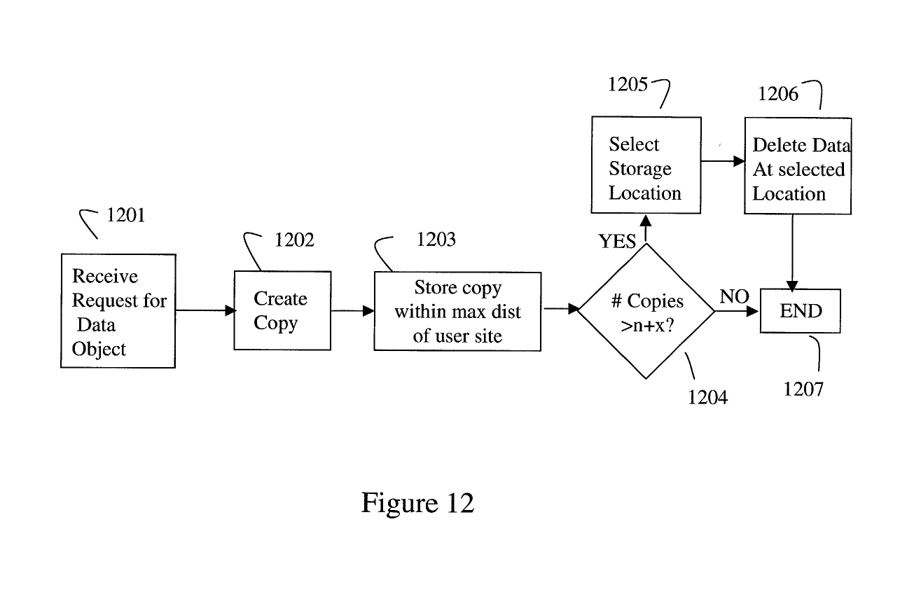

In another exemplary embodiment of the present invention as illustrated in FIG. 12, a request for a data object may be received from a user site (step 1201). A copy of the data object may be made (step 1202) and stored at a storage location in the network that is within a predetermined distance from the user site (step 1203). The total number of copies of the data object may be determined in the network or networks (step 1204); and if the total number of copies of the data object exceeds a maximum desired number of copies n+x, a selected storage site is determined (step 1205) and a copy of the data object is deleted from the selected storage site (step 1206). The selection of storage location where the data object is deleted may be selected based on a variety of factors such as but not limited to geographic location of the storage location, capacity of the storage location, storage space data, size of the stored data object, last accessed time of the data object, or number of accesses of the data object, for example.

In all of the exemplary embodiments of the invention, related tasks may occur in parallel. For example, subject to minimum distance separation, minimum count, and maximum count requirements, perfectly valid configurations of copies (where by configuration, we mean a specific mapping of object copies to locations) may be transformed to other valid configurations of copies. For example, if a New York server is at 90% storage capacity utilization, and the Washington, D.C., server is at 50%, some object copies could be shifted to Washington from New York to balance load and free New York for other data objects which might be desired by New York users. Also, managing changes to a replicated set of data should be done in conjunction with the principles of the invention described here. For example, if five copies of the data exist and a master is changed, all copies should be updated using means as are known in the art, such as locking all copies of the object, distributing the update, confirming or acknowledging that the updates have been received and applied to all copies, and then unlocking the object. If the object is not locked, then parallel but different changes may be applied to different copies of the object, and a mechanism must exist for conflict resolution.

Additional functions, not shown, may be required in implementing the system described here. For example, a management function may monitor storage capacity utilization and determine when more storage is required or less storage is required and physical devices may be retired or migrated to other locations, the average number of copies that exist, the amount of storage used for primary copies, secondary copies, tertiary copies, and above. Such a function means may also report when rules or constraints cannot be met—for example, when there aren't enough locations far enough apart to make n copies separated by distance d, or a copy can't be resident in New York because there is not sufficient spare capacity. Additionally, processes such as those illustrated in FIGS. 7 and 8 may be invoked when rules, constraints, resources, or requirements change, such as, for a given object or all objects, changes in n, x, or d, storage capacity adds or drops, new location adds or losses, disasters, planned maintenance outages, and the like.

One variation in which locations are added or dropped dynamically is when one or more of the nodes are on a mobile computing platform, such as a laptop. One can envision a case where a corporation has two copies of a mission critical data object, such as a customer presentation, one located in Miami, one in San Francisco. Now suppose that both of these copies are on nodes which are laptop computers, and executives carrying these laptops both go to New York for a meeting and bring their laptops. A location-sensing mechanism, such as Global Positioning System, built into their laptops, or other means, such as detecting where they attach to the network via a subnet or dial-in port, would now support the determination that the distance separation criterion d was no longer met, and therefore that the data would need to be replicated to another node.

While particular embodiments of the present invention have been described and illustrated, it should be understood that the invention is not limited thereto since modifications may be made by persons skilled in the art. It should be appreciated that many variations and modifications may be made without departing from the spirit and scope of the novel concepts of the subject invention. The present application contemplates any and all modifications that fall within the spirit and scope of the underlying invention disclosed and claimed herein and no limitation with respect to the specific apparatus and/or methods illustrated here are intended or should be inferred.

What is claimed is:

1. A system for managing at least one data object in a network comprising:
a plurality of storage locations, each of said storage locations capable of storing a copy of the data object;
a data manager for creating a copy or moving a copy of said data object to one of said storage locations; and
a counter for indicating a minimum number of storage locations in the network containing the data object,
wherein the data manager maintains the data object at the minimum number of storage locations in the network based on the counter.

2. The system of claim 1 wherein each of said storage locations in the network possesses at least one attribute and is configured to determine a function based on said attribute.

3. The system of claim 2 wherein the attribute comprises a geographic location.

4. The system of claim 2 wherein the function comprises a distance between said storage locations in the network.

5. The system of claim 1 wherein each storage location comprises a computer memory.

6. The system of claim 1 further comprising a data request component for receiving a data request from a site and for transferring the data object to a storage location within a predetermined distance of said site.

7. The system of claim 1 wherein the data manager includes storage location information.

8. The system of claim 7 wherein the storage location information comprises at least one of a storage space data, size of data objects, last accessed time of data objects, number of accesses of data objects, or local geographic information.

9. A method of managing a data object in a network comprising:
receiving the data object;
determining a minimum distance between a plurality of storage locations in a network;
selecting at least on storage location based on the minimum distance;
creating a plurality of copies of the data object; and
storing each copy of the plurality of copies of the data object at a selected storage location in the network.

10. The method of claim 9 wherein the plurality of copies comprises at least n copies of the data object, n being a desired minimum number of copies of the data object.

11. The method of claim 9 wherein said creating comprises:
determining n, n being a desired minimum number of copies of the data object; and
forming at least n−1 copies-of the data object.

12. A method of managing a data object in a network comprising:
determining the number of a plurality of storage locations in the network each containing a copy of the data object;
obtaining a desired minimum number of copies of the data object; and
storing a copy of the data object at a selected storage location in the network if the actual number of copies of the data is less than the desired minimum number,
wherein the selected storage location is separated by at least a distance d from at least one other storage locations in the network containing a copy of the data object, d being a predetermined minimum distance.

13. The method of claim 12 further comprising the step of calculating the predetermined minimum distance d.

14. The method of claim 13 wherein said calculating step comprises determining the geographic location of the storage location.

15. A method of managing a data object in a network comprising:
receiving a modified data object;
determining which of a plurality of storage locations contains the data object;
obtaining a minimum number of storage locations containing the data object; and
replacing each data object at each storage location with the modified data object such that at least the minimum number of storage locations contain the modified data object and each storage location containing the modified data object is separated by at least d, d being a predetermined minimum distance.

16. The method of claim 15 further comprising the step of calculating the predetermined minimum distance d.

17. The method of claim 16 wherein said calculating comprises determining the geographic location of the storage location.

18. A method of managing a data object in a network comprising:
determining an actual number of a plurality of storage locations in the network that each contain a copy of the data object;
obtaining a maximum number of copies of the data object; and
deleting a copy of the data object from a storage location if the actual number of copies of the data is greater than the maximum number of copies of the data object.

19. The method of claim 18 wherein the maximum number of copies of the data object is equal to n+x, n being a desired minimum number of copies of the data object and x being a maximum additional number of copies of the data object.

20. The method of claim 18 wherein said deleting comprises:
determining an attribute of each storage location containing a copy of the data object;
selecting the copy of the data object based on the attribute of the storage location containing the data object; and
deleting the selected copy of the data object.

21. The method of claim 20 wherein the attribute comprises at least one of storage space data, size of the stored data object, last accessed time of the data object, number of accesses of the data object, or local geographic information.

22. The method of claim 18 further comprising calculating x, said calculating comprising determining the geographical location of the storage location.

23. A method of managing a data object in a network comprising:
determining a plurality of storage locations in a network containing the data object; and
deleting the data object at each determined storage location.

24. The method of claim 23 further comprising broadcasting a deletion message to all storage locations via a multicast protocol.

25. The method of claim 24 wherein said multicast protocol is Protocol Independent Multicast-Sparse Mode (PIM-SM).

26. A method of managing a data object in a network comprising:
receiving a request to access a data object from a user site;
generating a copy of the data object; and
storing the generated copy of the data object at a storage location wherein the storage location is within a predetermined distance from the user site.

27. The method of claim 26 further comprising after said generating step:
determining the number of a plurality of storage locations in the network containing a copy of the data object;
obtaining a desired minimum number of copies of the data object;
selecting a storage location in the network containing a copy of the data object; and
deleting the copy of the data object at the selected storage location if the actual number of storage locations containing a copy of the data object is greater than the desired minimum number of copies.

28. The method of claim 27 wherein said selecting comprises determining an attribute of the storage locations containing a copy of the data object.

29. The method of claim 28 wherein the attribute comprises at least one of storage space data, size of the stored data object, last accessed time of the data object, number of accesses of the data object, or local geographic information.

30. A server for maintaining information on data in network nodes, the server comprising:
a node table for storing node information;
a node distance table for storing distance information between nodes;
an object copy table for maintaining data copy information; and
an object data and rules table.
